(19) United States
(12) Patent Application Publication
(10) Pub. No.: US 2017/0005727 A1
(43) Pub. Date: Jan. 5, 2017

(54) TRANSMISSION LOSS MEASUREMENT DEVICE, TRANSMISSION LOSS MEASUREMENT METHOD, AND OPTICAL TRANSMISSION SYSTEM

(71) Applicant: FUJITSU LIMITED, Kawasaki-shi (JP)

(72) Inventor: Yoshito KACHITA, Kawasaki (JP)

(73) Assignee: FUJITSU LIMITED, Kawasaki-shi (JP)

(21) Appl. No.: 15/185,227

(22) Filed: Jun. 17, 2016

(30) Foreign Application Priority Data
Jul. 3, 2015 (JP) 2015-134179

(51) Int. Cl. H04B 10/079; H04J 14/02

(52) U.S. Cl. CPC H04B 10/07955; H04J 14/02

(57) ABSTRACT

A transmission loss measurement device includes: a first monitor configured to measure a first optical power of a specific wavelength among wavelength-multiplexed light amplified by a Raman amplifier according to a power of pump light, the wavelength-multiplexed light being transmitted to an optical transmission line; a second monitor configured to measure a second optical power of the specific wavelength among the wavelength-multiplexed light received from the optical transmission line; a storage device configured to store a procedure for calculate a transmission line loss; and a processor configured to execute the procedure by: calculating a gain by the Raman amplifier, based on the power of the pump light; calculating the transmission line loss based on the first optical power, the second optical power, and the gain by the Raman amplifier; and correcting the transmission line loss according to a change of a number of wavelengths of the wavelength-multiplexed light.

### CROSS-REFERENCE TO RELATED APPLICATIONS

This application is based upon and claims the benefit of priority of the prior Japanese Patent Application No. 2015-134179 filed on Jul. 3, 2015, the entire contents of which are incorporated herein by reference.

### FIELD

The embodiments discussed herein are related to a transmission loss measurement device, a transmission loss measurement method, and an optical transmission system.

### BACKGROUND

The optical transmission system may include an optical amplifier or an optical add-drop multiplexer (OADM). An example of the optical transmission system is a WDM optical transmission system that transmits a WDM (wavelength division multiplexing) light obtained by wavelength-multiplexing of signal light having plurality of wavelengths.

In an OADM, a wavelength selective switch (WSS) may be used. When the WSS is used in the OADM, a transmission path of a signal light may be flexibly set in a unit of wavelength.

In order to compensate for a loss to which a signal light is subjected in an OADM or a loss to which the signal light is subjected in an optical transmission line (also, may be referred to as a “transmission line loss”), an optical amplifier may be provided at one or both of a previous stage and a post stage of the OADM.

The optical amplifier provided at the post stage of the OADM may be referred to as a “transmission amplifier” or a “post-amplifier.” The optical amplifier provided at the previous stage of the OADM may be referred to as a “reception amplifier” or a “pre-amplifier.”

As the optical amplifier, an erbium-doped fiber amplifier (EDFA) that uses an EDF (erbium-doped fiber) as an optical amplifying medium, a semiconductor optical amplifier (SOA), or a Raman amplifier may be employed. The Raman amplifier amplifies a signal light using stimulated Raman scattering (SRS).

Related techniques are disclosed in, for example, Japanese Laid-Open Patent Publication No. 2004-240278, International Publication Pamphlet No. WO 2006/137123, and Japanese Laid-Open Patent Publication No. 2012-22260.

### SUMMARY

According to an aspect of the invention, a transmission loss measurement device includes: a first monitor configured to measure a first optical power of a specific wavelength among wavelength-multiplexed light amplified by a Raman amplifier according to a power of pump light, the wavelength-multiplexed light being transmitted to an optical transmission line; a second monitor configured to measure a second optical power of the specific wavelength among the wavelength-multiplexed light received from the optical transmission line; a storage device configured to store a procedure for calculate a transmission line loss of the optical transmission line; and a processor configured to execute the procedure by: calculating a gain by the Raman amplifier, based on the power of the pump light; calculating the transmission line loss based on the first optical power measured by the first monitor, the second optical power measured by the second monitor, and the gain by the Raman amplifier; and correcting the transmission line loss according to a change of a number of wavelengths of the wavelength-multiplexed light.

The object and advantages of the invention will be realized and attained by means of the elements and combinations particularly pointed out in the claims.

It is to be understood that both the foregoing general description and the following detailed description are exemplary and explanatory and are not restirctive of the invention, as claimed.

### BRIEF DESCRIPTION OF DRAWINGS

FIG. 1 is a block diagram illustrating an example of a configuration of an optical transmission system according to an embodiment;

FIG. 2 is a block diagram for explaining Raman amplification in the optical transmission system exemplified in FIG. 1;

FIG. 3 is a flow chart illustrating an example of a transmission loss measurement method in the optical transmission system exemplified in FIG. 1;

FIG. 4 is a flow chart illustrating an example of a transmission loss measurement method in the optical transmission system exemplified in FIG. 1;

FIG. 5 is a view illustrating an example of a relationship between a pump light power and a Raman gain according to an embodiment;

FIG. 6 is a view illustrating an example of a relationship between a transmission amplifier total optical output power and an SRS correction value according to an embodiment;

FIG. 7 is a view illustrating an example of a relationship between a transmission amplifier total optical output power and an pump light variation amount according to an embodiment; and

FIG. 8 is a block diagram illustrating a configuration example of a transmission loss calculator exemplified in FIG. 1.

### DESCRIPTION OF EMBODIMENTS

In the optical transmission system, a measurement of a transmission line loss at a transmission section (also, referred to as a “span”) may be required. A transmission line loss of a span may be referred to as a “span loss.” For example, a measurement of a span loss between OADMs may be required.

When a post-amplifier is provided at the post stage of a first OADM, and a pre-amplifier is provided at the previous stage of a second OADM, a span loss between the OADMs may be obtained as a span loss between the post-amplifier and the pre-amplifier.

For example, the span loss between the post-amplifier and the pre-amplifier may be obtained by a difference between an optical output power of the post-amplifier and an optical input power of the pre-amplifier. Here, when a transmission line loss is measured on an optical transmission line used for a Raman amplifier, it is necessary to take the influence of a Raman gain into consideration.

For example, by subtracting a Raman gain from the transmission line loss obtained by the difference between the optical output power of the post-amplifier and the optical input power of the pre-amplifier, the transmission line loss of the optical transmission line that uses the Raman amplifier may be obtained.

The Raman gain may be obtained based on a predetermined relationship between a Raman gain and a measured pump light power obtained by measuring the power of a pump light output from a pump light source for the Raman amplifier. However, the Raman gain obtained as described above based on the predetermined relationship for the pump light power is not an actually measured value, and thus an error may occur.

For example, when an optical output power of the post-amplifier is varied according to a variation of the number of wavelengths of the WDM signal light, an SRS amount in the optical transmission line may be varied, and thus the Raman gain may be varied. Also, according to the variation of the number of wavelengths of the WDM signal light, in order to maintain the required same Raman gain, a pump light power may be varied.

When the pump light power is varied, although the Raman gain is maintained and is not varied, a variation may occur in a Raman gain obtained based on a predetermined relationship from the measured pump light power to cause an error.

As described above, according to the variation of the number of wavelengths of the WDM signal light, the SRS amount or the pump light power may be varied, thereby causing a measurement error in the transmission line loss.

Hereinafter, descriptions will be made on an embodiment of a technology that is capable of improving a measurement accuracy of a transmission line loss in an optical transmission section using a Raman amplifier, with reference to drawings. However, the embodiment described below is merely illustrative and is not intended to exclude various modifications and applications of techniques not specified below. Further, various exemplary aspects to be described below may also be implemented in combination as appropriate. In the drawings used in the following embodiment, portions denoted by the same reference numerals, unless otherwise specified, represent the same or like portions.

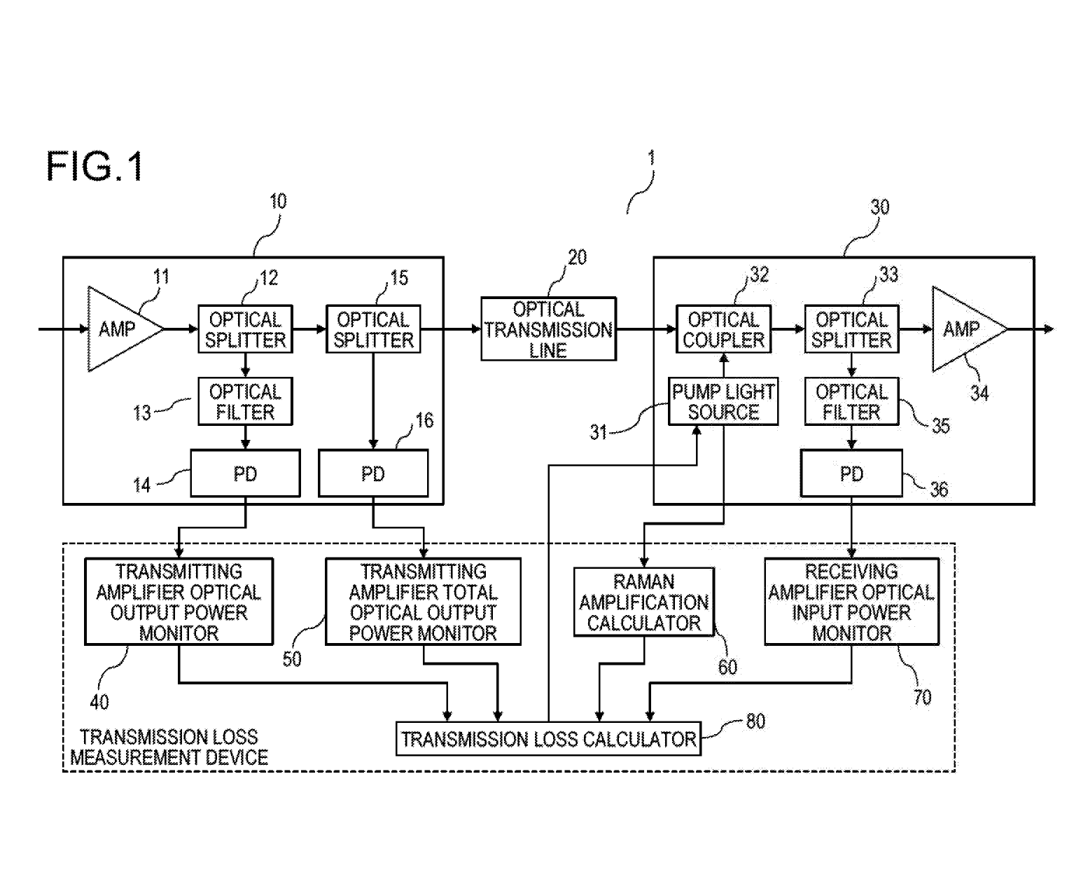

FIG. 1 is a block diagram illustrating an example of a configuration of an optical transmission system according to an embodiment. The optical transmission system 1 illustrated in FIG. 1 is, for example, a WDM optical transmission system that transmits a WDM light obtained by wavelength-multiplexing of light having a plurality of wavelengths, and may include an optical transmitting amplifier 10 and an optical receiving amplifier 30.

The optical transmitting amplifier 10 and the optical receiving amplifier 30 may be connected to each other, for example, via an optical transmission line 20 in an optically communicable manner. The optical transmission line 20 may be an optical fiber transmission line using an optical fiber.

Meanwhile, for convenience, the optical transmitting amplifier 10 may be referred to as a transmission amplifier 10, or a post-amplifier 10, and the optical receiving amplifier 30 may be referred to as a reception amplifier 30 or a pre-amplifier 30.

The transmission amplifier 10 may include, for example, an optical amplifier AMP 11, an optical splitter 12, an optical filter 13, a photodetector 14, an optical splitter 15, and a photodetector 16.

The optical amplifier 11 amplifies input light (e.g., WDM light). As the optical amplifier 11, for example, a rare earth-doped optical fiber amplifier or a semiconductor amplifier (SOA) may be employed. An example of the rare earth-doped optical fiber amplifier is an EDFA.

The optical splitter 12 splits, for example, output light of the optical amplifier 11, and outputs one light to the optical filter 13, and the other light to the optical splitter 15.

The optical filter 13 passes a light having one wavelength among a plurality of wavelengths included in the WDM light input from the optical splitter 12, to the photodetector 14. As the optical filter 13, a tunable optical filter capable of varying the wavelength of the light to be passed to the photodetector 14 may be employed. Further, the optical filter 13 may be replaced with, for example, a WSS.

The photodetector 14 receives, for example, the light having the wavelength that has passed through the optical filter 13, and outputs an electrical signal corresponding to the received optical power. As the photodetector 14, a photodiode (PD) or a photodetector may be employed. The electrical signal output by the PD 14 may be a current signal corresponding to the received optical power. The current signal may be converted into, for example, a voltage signal by a transimpedance amplifier (TIA).

The optical splitter 15 splits, for example, the WDM light input from the optical splitter 12, and outputs one light to the optical transmission line 20, and the other light to the photodetector 16.

The photodetector 16 receives, for example, the WDM light input from the optical splitter 15, and outputs an electrical signal corresponding to the received optical power. As the photodetector 16, as in the photodetector 14, a PD may be employed. The current signal output from the PD 16 may be converted into, for example, a voltage signal by a TIA.

Meanwhile, the reception amplifier 30 may include, for example, a pump light source 31, an optical coupler 32, an optical splitter 33, an optical amplifier AMP 34, an optical filter 35, and a photodetector 36.

The pump light source 31 generates, for example, a pump light for Raman amplification (for convenience, referred to as “Raman pump light”) and outputs the generated pump light to the optical coupler 32. The pump light source 31 may monitor the power of the pump light that is being output to the optical coupler 32, and the monitoring result may be given to a Raman amplification calculator 60 to be described later. Meanwhile, “monitor” may be interchangeably used as “measure” or “detect.”

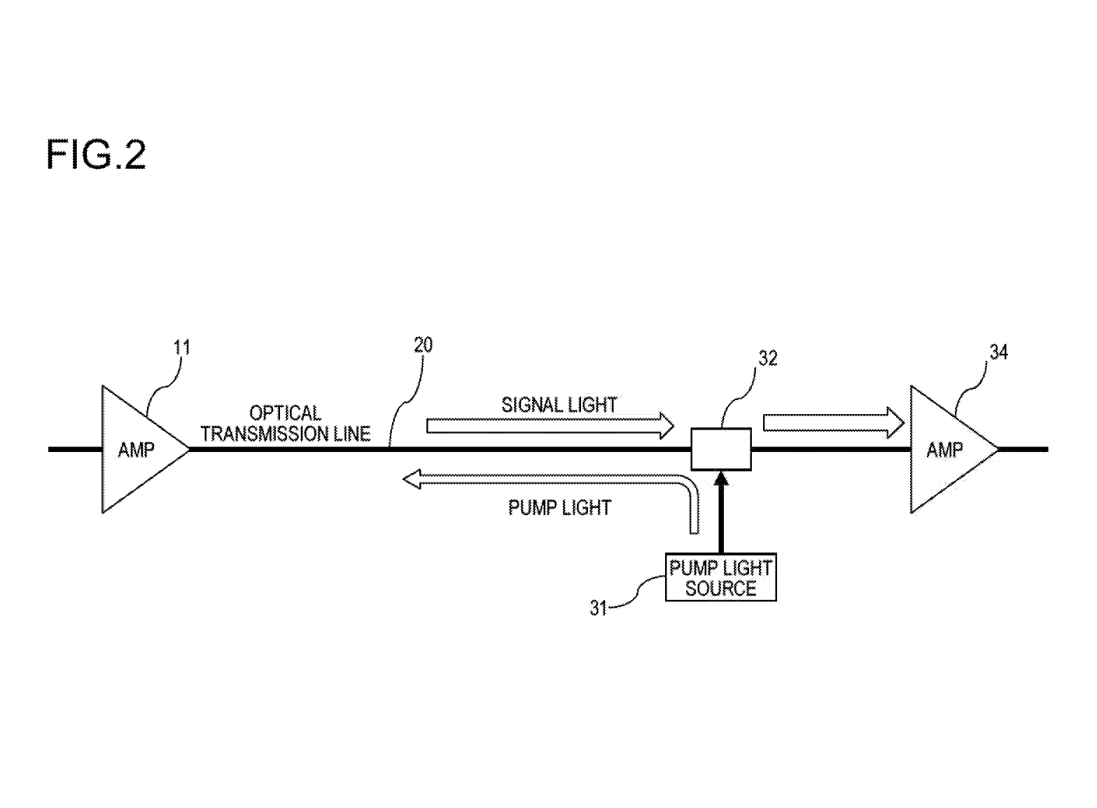

The optical coupler 32 passes, for example, the WDM light input from the optical transmission line 20 to the optical splitter 33, and outputs the Raman pump light input from the pump light source 31 to the optical transmission line 20. Accordingly, as schematically exemplified in FIG. 2, in the optical transmission line 20, the Raman pump light propagates in the reverse direction to the propagation direction of the WDM light which is an example of the signal light.

The optical transmission line 20 is an example of an optical amplification medium of a Raman amplifier, and the WDM light propagated through the optical transmission line 20 is Raman-amplified according to the power of the Raman pump light input to the optical transmission line 20. Meanwhile, a configuration where the Raman amplification is performed by the Raman pump light propagated in the reverse direction to the main signal light may be referred to as a “backward pumping” configuration.

The optical splitter 33 splits, for example, the WDM light input from the optical coupler 32, and outputs one light to the optical amplifier 34, and the other light to the optical filter 35.

The optical amplifier 34 amplifies the WDM light input from the optical splitter 33. As the optical amplifier 34, for example, a rare earth-doped optical fiber amplifier or a semiconductor amplifier (SOA) may be employed. An example of the rare earth-doped optical fiber amplifier is an EDFA.

The optical filter 35 passes a light having any wavelength among a plurality of wavelengths included in the WDM light input from the optical splitter 33, to the photodetector 36. As the optical filter 35, a tunable optical filter capable of varying the wavelength of the light to be passed to the photodetector 36 may be employed. Further, the optical filter 35 may be replaced with, for example, a WSS.

The photodetector 36 receives, for example, the light having the wavelength that has passed through the optical filter 35, and outputs an electrical signal corresponding to the received optical power. As the photodetector 36, as in the photodetectors 14 and 16 of the transmission amplifier 10, a PD may be employed. The current signal output from the PD 36 may be converted into, for example, a voltage signal by a TIA.

Also, as exemplified in FIG. 1, the optical transmission system 1 may include a transmitting amplifier optical output power monitor 40, a transmitting amplifier total optical output power monitor 50, a Raman amplification calculator 60, a receiving amplifier optical input power monitor 70, and a transmission loss calculator 80.

The transmitting amplifier optical output power monitor 40 monitors, for example, the electrical signal corresponding to a received optical power at the photodetector 14. That is, the transmitting amplifier optical output power monitor 40 monitors a transmitted optical power P_{Tx} with a specific wavelength (also, referred to as a “monitor wavelength” for convenience), which is transmitted to the optical transmission line 20. The monitoring result of the transmitting amplifier optical output power monitor 40 may be provided to the transmission loss calculator 80.

The transmitting amplifier total optical output power monitor 50 monitors, for example, the electrical signal corresponding to a received optical power at the photodetector 16. That is, the transmitting amplifier total optical output power monitor 50 monitors a total transmitted optical power P^{TxTotal} of the WDM light transmitted to the optical transmission line 20. The monitoring result of the transmitting amplifier total optical output power monitor 50 may be provided to the transmission loss calculator 80.

The Raman amplification calculator 60 obtains, for example, a Raman amplification amount P_{Raman} based on the power of the Raman pump light that is being output from the pump light source 31. The Raman amplification amount represents the amount of amplification that is obtained by the present power of the Raman pump light. The “Raman amplification amount” may be regarded as information equivalent to “Raman gain” for convenience.

The receiving amplifier optical input power monitor 70 monitors, for example, the electrical signal corresponding to the received optical power at the photodetector 36. That is, the receiving amplifier optical input power monitor 70 monitors a received optical power P_{Rx} of a light with a specific monitor wavelength, which is received from the optical transmission line 20. The monitoring result of the receiving amplifier optical input power monitor 70 may be provided to the transmission loss calculator 80.

The transmitting amplifier optical output power monitor 40 is an example of a first monitor, the receiving amplifier optical input power monitor 70 is an example of a second monitor, and the transmitting amplifier total optical output power monitor 50 is an example of a third monitor.

The transmission loss calculator 80 may calculate the transmission line loss to which the WDM light is subjected in the optical transmission line 20 between the transmission amplifier 10 and the reception amplifier 30, for example, based on the monitoring results of the transmitting amplifier optical output power monitor 40, the transmitting amplifier total optical output power monitor 50, and the receiving amplifier optical input power monitor 70, and the

Raman amplification amount calculated by the Raman amplification calculator 60. The section between the transmission amplifier 10 and the reception amplifier 30 may be referred to as a “span,” and thus, the transmission line loss in the span may be referred to as a “span loss.”

For example, the transmission loss calculator 80 may calculate a transmission line loss P_{Loss} (dB) by the following equation (1).

P_{Loss}[dB]=P_{Tx}[dBm]−P_{Rx}[dBm]−P_{Raman}[dB]+P_{converted}[dB]+P_{correct}[dB] (1)

Wherein the “P_{converted}” represents a “conversion value” of a transmission line loss, and “P_{correct}” represents a “correction value” of a transmission line loss.

The conversion value “P_{converted}” is a value for converting the transmission line loss P_{Loss} into a loss of a wavelength at which a transmission line loss needs to be measured (for convenience, also referred to as a “target wavelength”) when the obtained monitor wavelength of P_{Tx} and P_{Rx} is a wavelength different from the target wavelength. Thus, when the monitor wavelength is coincident with the target wavelength, the conversion value “P_{converted}” may not be used.

The correction value “P_{correct}” may be calculated based on, for example, one or both of an “SRS correction value” and a “pump light variation correction value.”

The “SRS correction value” is, for example, a value for correcting a variation of an SRS amount because when the number of wavelengths of the WDM light transmitted to the optical transmission line 20 is changed and the total power of the transmitted WDM light is changed, the SRS amount in the transmission band of the WDM light is varied according to the change.

For example, there is a tendency that when the total power is increased according to an increase of the number of wavelengths of the transmitted WDM light, the SRS amount is also increased. Therefore, the “SRS correction value” may be set as, for example, a value (e.g., a subtraction value) capable of offsetting an increased amount of the SRS amount according to an increase of the total transmission power of the WDM light. Meanwhile, the total power of the transmitted WDM light may be monitored by, for example, the transmitting amplifier total optical output power monitor 50.

Meanwhile, the “pump light variation correction value” is, for example, a value for correcting a variation of the Raman gain according to a variation of the pump light power because when the number of wavelengths of a WDM light transmitted to the optical transmission line 20 is changed, the pump light power for maintaining the same Raman gain with respect to the WDM light is varied.

For example, as the number of wavelengths of the transmitted WDM light is increased, there is a tendency that the pump light power for maintaining the same Raman gain with respect to the WDM light is also increased. When it is assumed that the Raman gain is increased according to an increase of the pump light power, an error may occur in a Raman gain that is actually kept constant regardless of the change in the number of wavelengths. The “pump light variation correction value” may be set as a value capable of offsetting such an error of a Raman gain.

That is, the transmission loss calculator 80 may control the pump light power of the pump light source 31 such that when the number of wavelengths of the transmitted WDM light is changed, the gain by the Raman amplifier may be kept at the same value before and after the change.

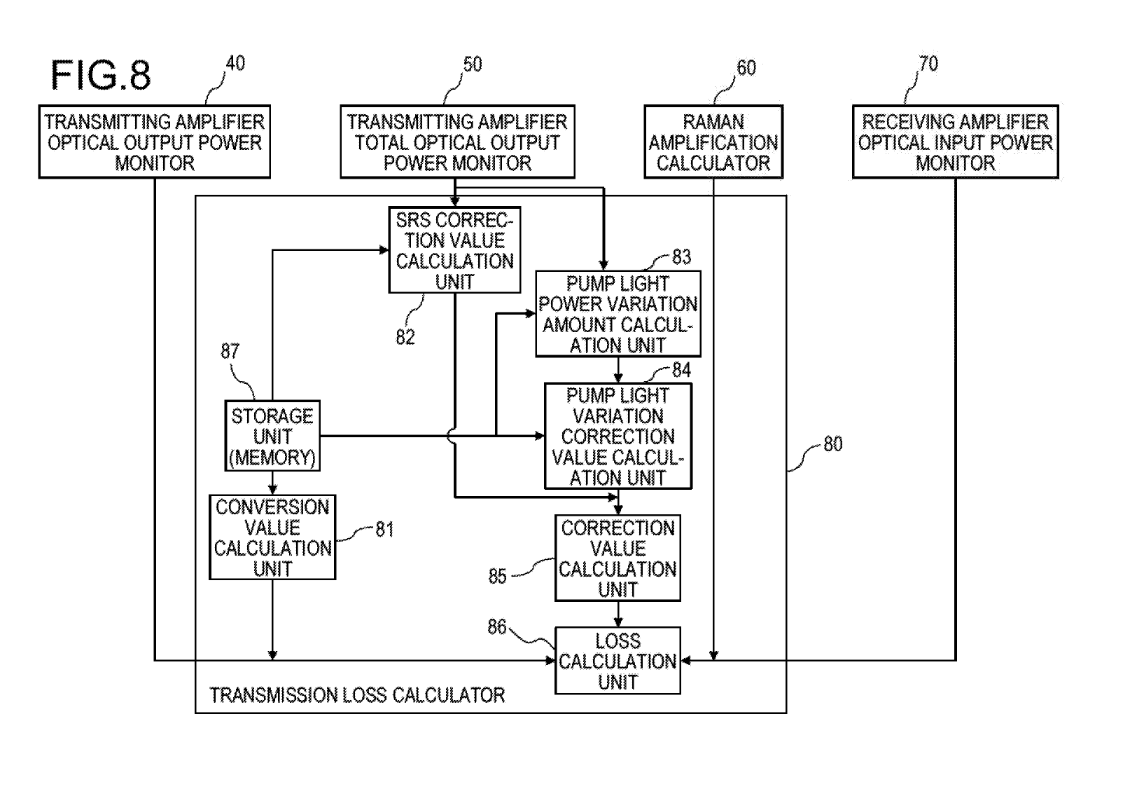

FIG. 8 illustrates a configuration example of the above-described transmission loss calculator 80. As exemplified in FIG. 8, the transmission loss calculator 80 may include, for example, a conversion value calculation unit 81, an SRS correction value calculation unit 82, a pump light power variation amount calculation unit 83, a pump light variation correction value calculation unit 84, a correction value calculation unit 85, a loss calculation unit 86, and a storage unit 87.

The conversion value calculation unit 81 may calculate a conversion value “P_{converted},” based on, for example, information for obtaining the conversion value “P_{converted}” as described above which is stored in the storage unit 87.

The SRS correction value calculation unit 82 may calculate the “SRS correction value” as described above based on, for example, the monitoring result of the transmitting amplifier total optical output power monitor 50.

The pump light power variation amount calculation unit 83 may calculate a variation amount of the pump light power based on, for example, the monitoring result of the transmitting amplifier total optical output power monitor 50.

The pump light variation correction value calculation unit 84 may calculate the “pump light variation correction value” as described above based on, for example, a variation amount of a pump light power calculated by the pump light power variation amount calculation unit 83.

The correction value calculation unit 85 may calculate the correction value “P_{correct}” as described above based on, for example, the “SRS correction value” calculated by the SRS correction value calculation unit 82, and the “pump light variation correction value” calculated by the pump light variation correction value calculation unit 84.

The loss calculation unit 86 may calculate the transmission line loss exemplified in Equation (1) based on, for example, the monitoring results of the monitors 40 and 70, the calculated result of the Raman amplification calculator 60, and the calculated results of the conversion value calculation unit 81 and the correction value calculation unit 85.

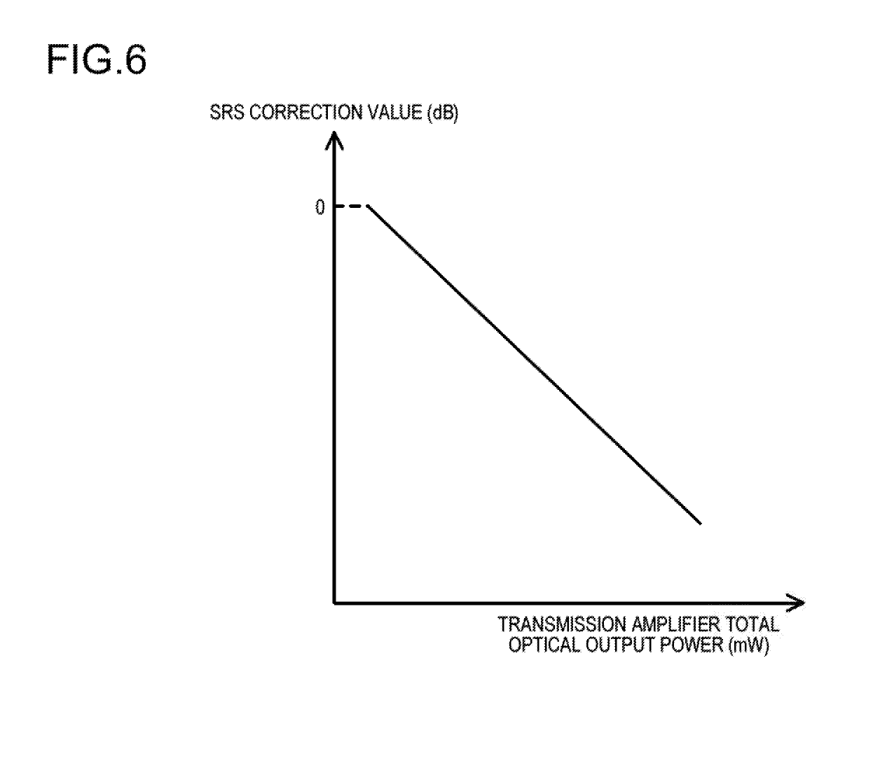

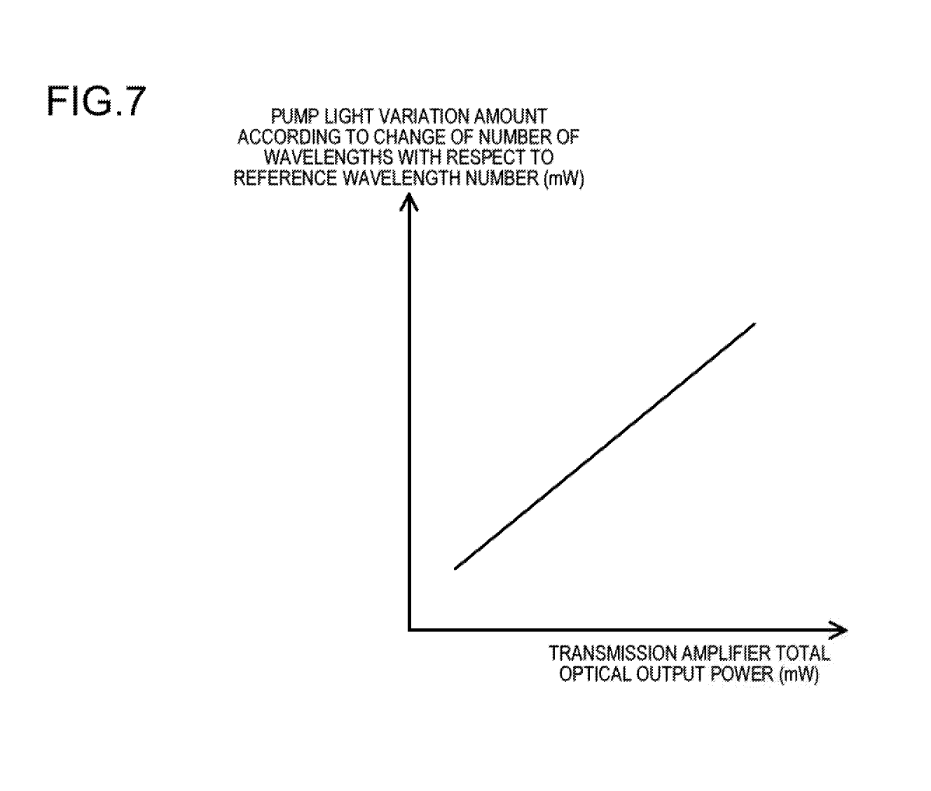

In the storage unit 87, information used for calculating the transmission line loss may be stored. The information used for calculating the transmission line loss may correspond to, for example, information indicating the above described “conversion value,” a conversion coefficient used for calculating the “conversion value” as described below, or relationships exemplified in FIGS. 6 and 7.

FIG. 6 is a view illustrating an example of a relationship between a transmission amplifier total optical output power and an SRS correction value, and FIG. 7 is a view illustrating an example of a relationship between a transmission amplifier total optical output power and an increase amount of a pump light power according to an increase of a number of wavelengths with respect to a reference number of wavelengths.

Meanwhile, as the storage unit 87, a memory such as a flash memory, or a storage device such as a hard disk drive (HDD), or a solid-state drive (SSD) may be employed. The storage unit 87 may be provided outside the transmission loss calculator 80.

The transmission amplifier 10 as described above may be provided in a first optical transmission device, and the reception amplifier 30 may be provided in a second optical transmission device. The “optical transmission device” may be called a “node” or a “station.”

A first node may be any one of a transmitting end node, a relay node (e.g., an in-line amplifier, ILA), and an ROADM. A second node may be any one of a receiving end node, a relay node, and an ROADM.

Some or all of the transmitting amplifier optical output power monitor 40, the transmitting amplifier total optical output power monitor 50, the receiving amplifier optical input power monitor 70, the Raman amplification calculator 60, and the transmission loss calculator 80 may be provided in any one of the first and second nodes.

For example, the monitors 40 and 50 may be provided in the first node, and the Raman amplification calculator 60, the monitor 70, and the transmission loss calculator 80 may be provided in the second node.

Alternatively, the monitors 40 and 50, and the transmission loss calculator 80 may be provided in the first node, and the Raman amplification calculator 60 and the monitor 70 may be provided in the second node.

For example, an optical supervisory channel (OSC) may be used in transmission of monitoring results or calculation results to the transmission loss calculator 80.

Also, some or all of the transmitting amplifier optical output power monitor 40, the transmitting amplifier total optical output power monitor 50, the receiving amplifier optical input power monitor 70, the Raman amplification calculator 60, and the transmission loss calculator 80 may be provided in a system (e.g., NMS or OPS) capable of controlling and managing the overall operation of the optical transmission system 1. Meanwhile, the “NMS” is an abbreviation of a network management system, and the “OPS” is an abbreviation of an operation system.

Also, some or all of the transmitting amplifier optical output power monitor 40, the transmitting amplifier total optical output power monitor 50, the receiving amplifier optical input power monitor 70, the Raman amplification calculator 60, and the transmission loss calculator 80 may be implemented by hardware or software processing.

For example, the Raman amplification calculator 60 and the transmission loss calculator 80 may be implemented by one or more processor. In such a case, the one or more processor is included in one or more of the Raman amplification calculator 60, the conversion value calculation unit 81, the SRS correction value calculation unit 82, the pump light power variation amount calculation unit 83, the pump light variation correction value calculation unit 84, the correction value calculation unit 85, and the loss calculation unit 86, and functions of the Raman amplification calculator 60, the conversion value calculation unit 81, the SRS correction value calculation unit 82, the pump light power variation amount calculation unit 83, the pump light variation correction value calculation unit 84, the correction value calculation unit 85, and the loss calculation unit 86 are implemented by software processing. Furthermore, a procedure for the software processing may be stored in the storage unit 87.

Meanwhile, it may be considered that the transmitting amplifier optical output power monitor 40, the transmitting amplifier total optical output power monitor 50, the receiving amplifier optical input power monitor 70, the Raman amplification calculator 60, and the transmission loss calculator 80 form an example of a transmission loss measurement device, as exemplified by a dotted frame in FIG. 1.

### Operation Example

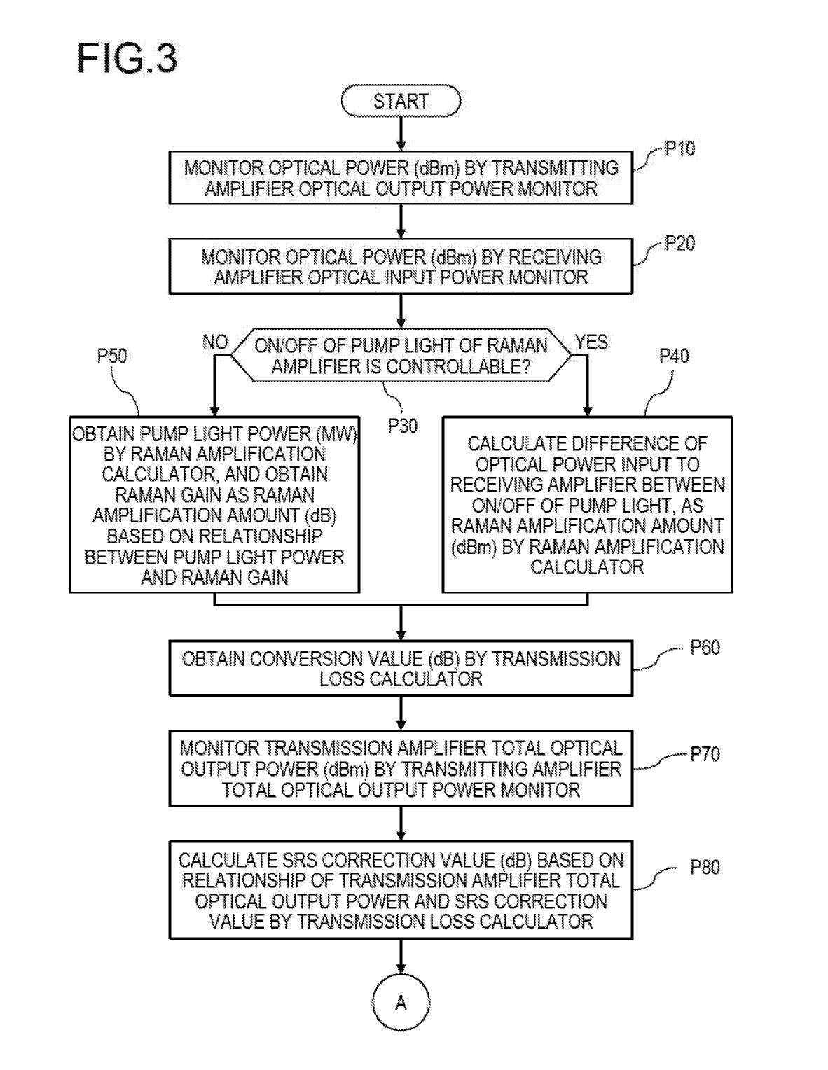

Hereinafter, descriptions will be made on a measurement example of a transmission line loss in the optical transmission system 1 exemplified in FIG. 1, with reference to FIGS. 3 to 7.

As exemplified in FIG. 3, in the transmitting amplifier optical output power monitor 40, an optical output power of a monitor wavelength is monitored (operation P10). In the receiving amplifier optical input power monitor 70, an optical input power of the monitor wavelength is monitored (operation P20). The order of these operations P10 and P20 is unregarded, and may be implemented in parallel.

Also, in the Raman amplification calculator 60, a Raman amplification amount P_{Raman} is calculated. For example, at the start-up of the optical transmission system 1 or prior to an operation start-up of the optical transmission system 1, a relationship between a pump light power and a Raman amplification amount is obtained for a case where the optical transmission line 20 and the pump light source 31 are used.

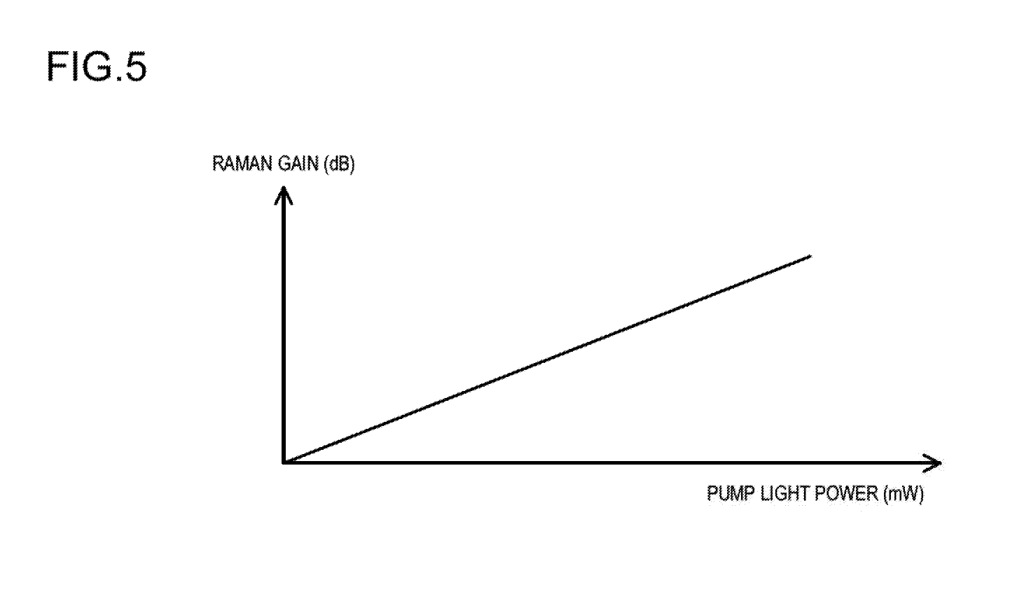

An example of the relationship is illustrated in FIG. 5. As exemplified in FIG. 5, the pump light power and the Raman amplification amount have a relationship in which according to an increase of the pump light power (mW), the Raman amplification amount (dB) is also increased.

As before an operation start-up of the optical transmission system 1, when the pump light source 31 may be controlled to be turned ON/OFF (YES in Operation P30), the Raman amplification amount P_{Raman} may be obtained by the following equation (2) (Operation P40).

P_{Raman}=P_{RxRamanON}−P_{RxRamanOFF} (2)

Wherein, in Equation (2), “P_{RxRamanON}” represents an optical power monitored by the receiving amplifier optical input power monitor 70 when the pump light source 31 is controlled to be turned ON. Wherein, “P_{RxRamanOFF}” represents an optical power monitored by the receiving amplifier optical input power monitor 70 when the pump light source 31 is controlled to be turned OFF.

The calculation expressed by Equation (2) may be implemented by, for example, the transmission loss calculator 80, or the Raman amplification calculator 60. In a case where the calculation is implemented by the Raman amplification calculator 60, information of the optical power monitored by the receiving amplifier optical input power monitor 70 when the pump light source 31 is controlled to be turned ON and OFF, may be provided to the Raman amplification calculator 60.

As after an operation start-up of the optical transmission system 1, when the pump light source 31 may not be controlled to be turned ON/OFF (No in Operation P30), for example, the Raman amplification calculator 60 obtains a present pump light power of the pump light source 31. The Raman amplification calculator 60 may obtain the Raman gain for the present pump light power from the relationship exemplified in FIG. 5, as a Raman amplification amount (Operation P50).

Meanwhile, the Raman amplification amount may be obtained in consideration of noise. For example, an optical power monitored by the receiving amplifier optical input power monitor 70 when the pump light source 31 is controlled to be turned ON in a state where a signal light is not transmitted, is represented by “P_{RXRamanONNoch},” and an optical power monitored by the receiving amplifier optical input power monitor 70 when the pump light source 31 is controlled to be turned OFF in a state where a signal light is not transmitted, is represented by “P_{RXRamanONNoch}.” In this case, noise at the time of Raman amplification may be obtained by P_{RXRamanONNoch}−P_{RXRamanOFFNoch}. Accordingly, the result obtained by subtracting the noise from the Raman amplification amount may be obtained as a Raman amplification amount in consideration of the noise.

Thereafter, in the transmission loss calculator 80, a conversion value P_{converted} in Equation (1) as mentioned above is obtained (Operation P60). The conversion value may be, for example, a conversion coefficient utilizing a ratio of a fiber wavelength-dependent loss between a wavelength band including a monitor wavelength used for calculating a transmission line loss and a wavelength band at which a transmission line loss needs to be measured. The conversion coefficient may be stored as a constant in, for example, the storage unit 87 provided in the transmission loss calculator 80.

The transmission loss calculator 80 obtains an SRS correction value, based on the optical power monitored by the transmitting amplifier total optical output power monitor 50, from the relationship between a transmission amplifier total optical output power and an SRS correction value as exemplified in FIG. 6 (operations P70 and P80).

As exemplified in FIG. 6, the SRS correction value (dB) is, for example, 0 (dB) (not corrected) with respect to the transmission amplifier total optical output power when the number of wavelengths is the reference number of wavelengths. When the transmission amplifier total optical output power is increased according to an increase of the number of wavelengths with respect to the reference number of wavelengths, the SRS correction value takes a larger subtraction value. Thus, it may be considered that the SRS correction value is associated with the number of wavelengths.

The relationship exemplified in FIG. 6 may be stored as information obtained by simulation or actual measurement, in, for example, the storage unit 87. As a non-limiting example, the relationship exemplified in FIG. 6 may be stored as database, for example, in the storage unit 87 of the transmission loss calculator 80 by checking an extent to which the influence by the SRS occurs on the wavelength band of the photodetector 36 of the reception amplifier 30.

The transmission loss calculator 80 obtains a pump light variation correction value based on the monitoring result of the transmitting amplifier total optical output power monitor 50.

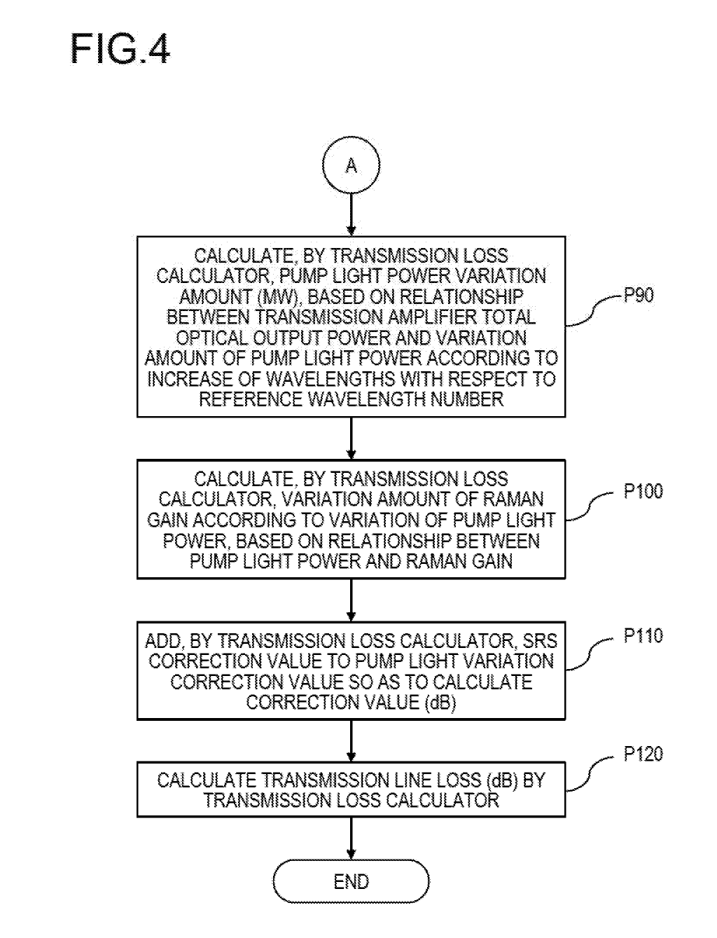

For example, the transmission loss calculator 80 calculates a variation amount of the pump light power based on the relationship between a transmission amplifier total optical output power and an increase amount of a pump light power according to an increase of the number of wavelengths with respect to a reference number of wavelengths as exemplified in FIG. 7 (Operation P90 of FIG. 4).

The relationship exemplified in FIG. 7 illustrates an extent to which a pump light power varies in order to generate the same Raman amplification amount when the total optical output power of the transmission amplifier 10 is changed with respect to the number of wavelengths at the time of measurement of the Raman amplification amount prior to the operation start-up of the optical transmission system 1.

The time when the total optical output power is changed is based on the assumption that the number of wavelengths is increased or decreased at the same power level for a light of each of wavelengths included in the WDM light. Thus, it may be considered that the variation amount of the pump light power is associated with the number of wavelengths. The relationship exemplified in FIG. 7 may be stored as information obtained by simulation or actual measurement, in, for example, the storage unit 87.

Further, the transmission loss calculator 80 calculates a variation amount of a Raman gain according to the variation amount of the pump light power, as a pump light variation correction value, based on the variation amount of the pump light power obtained based on the relationship exemplified in FIG. 7, and the relationship exemplified in FIG. 5 (Operation P100 of FIG. 4).

The transmission loss calculator 80 adds an SRS correction value calculated in operation P80 of FIG. 3 to the pump light variation correction value calculated in operation P100 of FIG. 4 so as to calculate a correction value P_{correct} in Equation (1) as described above (Operation P110 of FIG. 4).

Then, the transmission loss calculator 80 calculates a transmission line loss by Equation (1) based on the monitoring results P_{Tx} and P_{Rx} of the monitors 40 and 70, the calculation result P_{Raman} of the Raman amplification calculator 60, the conversion value P_{converted}, and the correction value P_{correct} (Operation P120 of FIG. 4).

By the correction value P_{correct}, the transmission line loss corrected according to the variation of the number of wavelengths is obtained. Accordingly, even when the number of wavelengths is varied, a transmission line loss of the transmission section in which the Raman amplifier is applied may be accurately obtained, thereby improving the measurement accuracy of the transmission line loss.

Meanwhile, in the flow charts exemplified in FIGS. 3 and 4, the conversion value, the SRS correction value, and the pump light variation correction value in Equation (1) are calculated in the order described above, but the calculation order may be properly changed. Alternatively, some or all of the conversion value, the SRS correction value, and the pump light variation correction value in Equation (1) may be calculated in parallel.

In the flow charts exemplified in FIGS. 3 and 4, the correction value P_{correct} is obtained as a sum of the SRS correction value and the pump light variation correction value. The correction value “P_{correct}” may be either one of the SRS correction value or the pump light variation correction value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission loss measurement device comprising:
a first monitor configured to measure a first optical power of a specific wavelength among wavelength-multiplexed light amplified by a Raman amplifier according to a power of pump light, the wavelength-multiplexed light being transmitted to an optical transmission line;
a second monitor configured to measure a second optical power of the specific wavelength among the wavelength-multiplexed light received from the optical transmission line;
a storage device configured to store a procedure for calculate a transmission line loss of the optical transmission line; and
a processor configured to execute the procedure by:
calculating a gain by the Raman amplifier, based on the power of the pump light;
calculating the transmission line loss based on the first optical power measured by the first monitor, the second optical power measured by the second monitor, and the gain by the Raman amplifier; and
correcting the transmission line loss according to a change of a number of wavelengths of the wavelength-multiplexed light.

2. The transmission loss measurement device according to claim 1,
wherein the processor controls the power of the pump light such that when the change of the number of wavelengths of the wavelength-multiplexed light occurs, the gain by the Raman amplifier is kept at a same value before and after the change.

3. The transmission loss measurement device according to claim 1,
wherein the processor corrects the transmission line loss, based on a stimulated Raman scattering amount corresponding to the number of wavelengths.

4. The transmission loss measurement device according to claim 1,
wherein the processor corrects the transmission line loss, based on a variation amount of a pump light power corresponding to the number of wavelengths.

5. A transmission loss measurement method comprising:
measuring a first optical power of a specific wavelength among wavelength-multiplexed light amplified by a Raman amplifier according to a power of pump light;
transmitting the wavelength-multiplexed light to an optical transmission line;
receiving the wavelength-multiplexed light from the optical transmission line;
measuring a second optical power of the specific wavelength among the wavelength-multiplexed light received from the optical transmission line;
calculating a gain by the Raman amplifier, based on the power of the pump light;
calculating a transmission line loss of the optical transmission line, based on the first optical power, the second optical power, and the gain; and
correcting the transmission line loss according to a change of a number of wavelengths of the wavelength-multiplexed light.

6. An optical transmission system comprising:
a first node configured to include a Raman amplifier to amplify wavelength-multiplexed light according to a power of pump light, and to transmit the wavelength-multiplexed light to an optical transmission line;
a second node configured to receive the wavelength-multiplexed light from the optical transmission line; and
a transmission loss measurement device configured to include
a first monitor configured to measure a first optical power of a specific wavelength among the wavelength-multiplexed light amplified by the Raman amplifier of the first node,
a second monitor configured to measure a second optical power of the specific wavelength among the wavelength-multiplexed light received by the second node,
a storage device configured to store a procedure for calculate a transmission line loss of the optical transmission line; and
a processor configured to execute the procedure by:
calculating a gain by the Raman amplifier, based on the power of the pump light;
calculating the transmission line loss based on the first optical power measured by the first monitor, the second optical power measured by the second monitor, and the gain by the Raman amplifier; and
correcting the transmission line loss according to a change of a number of wavelengths of the wavelength-multiplexed light.
